(19) United States
(12) Patent Application Publication
(10) Pub. No.: US 2015/0199399 A1
(43) Pub. Date: Jul. 16, 2015

(54) QUERY GENERATOR

(71) Applicants: Sebastian Schroetel, Heidelberg (DE); Zoltan Albrecht, Karlsruhe (DE); Felix Kampsen, Mannheim (DE); Wenja Shan, Karlsruhe (DE)

(72) Inventors: Sebastian Schroetel, Heidelberg (DE); Zoltan Albrecht, Karlsruhe (DE); Felix Kampsen, Mannheim (DE); Wenja Shan, Karlsruhe (DE)

(21) Appl. No.: 14/152,122

(22) Filed: Jan. 10, 2014

(51) Int. Cl. G06F 17/30

(52) U.S. Cl. CPC G06F 17/30392; G06F 17/30395

(57) ABSTRACT

The disclosure generally describes computer-implemented methods, computer-readable media, and computer systems for querying information. An identifier is received that is associated with a first query for obtaining summary information associated with one or more business objects. An indicator is received that requests parameters for generating a second query associated with the first query and operable for obtaining detailed information associated with the one or more business objects. The first query associated with the received identifier is executed to identify the summary information. The parameters are generated using metadata associated with the one or more business objects. The summary information and the parameters are provided in response to the received identifier and indicator

### TECHNICAL FIELD

The present disclosure relates to computer-implemented methods and systems for querying information.

### BACKGROUND

Queries can be used to obtain information from various data sources, including, for example, data bases, data warehouses, data objects, and other sources. A given query may provide summary information, detailed information, or a combination of both. Some users, for example, may be skilled at formulating queries. Other users who may have less ability in the formation of queries can rely on, for example, query builders or other tools that allow a query to be built that is syntactically correct and conforms to the requirements of the data source. When some queries are executed, for example, the user may not be satisfied with the amount or granularity of the query results. The user can then create and submit other queries.

### SUMMARY

The disclosure generally describes computer-implemented methods, computer-readable media, and computer systems for providing instructions for providing information. As an example, an identifier associated with a first query is received for obtaining summary information associated with one or more business objects. An indicator is received requesting parameters for creating a second query associated with the first query and operable for obtaining detailed information associated with the one or more business objects. The first query associated with the received identifier is executed to identify the summary information. The parameters are created using metadata associated with the one or more business objects. The summary information and the parameters are provided in response to the received identifier and indicator.

The present disclosure relates to computer-implemented methods, computer-readable media, and computer systems for providing and executing queries. One computer-implemented method includes: receiving an identifier associated with a first query for obtaining summary information associated with one or more business objects; receiving an indicator requesting parameters for creating a second query associated with the first query and operable for obtaining detailed information associated with the one or more business objects; executing, using one or more processors, the first query associated with the received identifier to identify the summary information; creating, using metadata associated with the one or more business objects, the parameters; and providing the summary information and the parameters in response to the received identifier and indicator.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect combinable with any of the previous aspects, the identifier is a technical name associated with an information provider and identified by the identifier.

In a second aspect combinable with any of the previous aspects, the summary information is based on predefined dimensions and key figures associated with the information provider.

In a third aspect combinable with any of the previous aspects, the second query is associated with a view describing a layout of the detailed information.

In a fourth aspect combinable with any of the previous aspects, the parameters include an executable instance of the second query.

In a fifth aspect combinable with any of the previous aspects, the parameters include building blocks that are usable by a user to formulate the second query.

In a sixth aspect combinable with any of the previous aspects, executing the first query includes, depending on at least a source of the first query, one of: providing a first result set that includes the summary information when an API is used for executing the first query; and providing a second result set that includes the summary information and the detailed information when the first query is executed in a native environment.

In a seventh aspect combinable with any of the previous aspects, the parameters are represented in a multi-dimensional expression language.

In an eighth aspect combinable with any of the previous aspects, the method further includes receiving the second query, executing the second query, and providing the detailed information in response to the received second query.

In a ninth aspect combinable with any of the previous aspects, the method further includes providing parameters for creating a third query associated with the second query and operable for obtaining additional detailed information associated with the one or more business objects, receiving the third query, executing the third query, and providing the additional detailed information in response to the received third query.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example environment for querying information according to an implementation.

FIG. 2A shows example query results associated with a first query executed in a native environment according to an implementation.

FIG. 2B shows example query results associated with the first query executed through an API according to an implementation.

FIG. 2C shows example query results associated with a second query for obtaining detailed information, including receiving the data and a layout, according to an implementation.

FIG. 3 shows a diagram of an example abstraction of a reporting application according to an implementation.

FIG. 4 shows a diagram of an example sequence of operations for the reporting application of FIG. 3 according to an implementation.

FIG. 5 shows a diagram of an example architecture for a server for handling multi-dimensional queries according to an implementation.

FIG. 6 shows a more detailed diagram of the example architecture shown in FIG. 5 according to an implementation.

FIG. 7 shows a diagram of an example mechanism for reading metadata for a given query name and converting the information into a multidimensional expression (MDX) statement according to an implementation.

FIG. 8 shows a swim lane diagram of an example sequence of operations for generating multi-dimensional query language statements according to an implementation.

FIG. 9A shows a diagram of example inputs for a get query statement function according to an implementation.

FIG. 9B shows example inputs for the get query statement function of FIG. 9A, according to an implementation.

FIG. 10 shows a flowchart of an example method for providing summary information and parameters for use in generating a query for associated detailed information according to an implementation.

Like reference numbers and designations in the various drawings indicate like elements.

### DETAILED DESCRIPTION

This disclosure generally describes computer-implemented methods, computer-readable media, and computer systems for using queries to access business-related information. The following description is presented to enable any person skilled in the art to practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

The subject matter described in this specification can be implemented in particular implementations so as to realize one or more of the following advantages. Users, including mobile users, can formulate and submit queries for detailed business-related information or other information without having to know the technical aspects needed to form the queries. For example, parameters or other information needed for queries, or the queries themselves, can be provided automatically to a user to obtain detailed and/or more relevant information associated with a query that provided summary information. Interoperability between different systems can be supported, e.g. using queries that can be used in and for multidimensional expression (MDX)-based systems.

In general, a data warehouse can provide business-related data information to users. Internal users can use internal queries to access both the data and data layouts. However, some data warehouses and related systems can restrict access to external users/clients. For example, some external access can be provided using MDX. However, MDX has a limitation in that external users cannot receive layout data that is otherwise available to internal users using direct calls to the data warehouse. Conventional systems can require an external user to research and learn specific layout information if detailed queries are to be formulated and submitted. However, the solution provided herein generally automatically provides the external user with layout information needed to easily generate the detailed queries.

Warehouse data access systems can provide users with the ability to gather and consolidate business relevant data. In some implementations, e.g., for reporting purposes based on a specific central data warehouse, the data can be grouped by various criteria, such as by an information provider and/or other criteria. Reporting requests, including queries, can then be based on the various criteria. In the case of a report request query based on a specific information provider, each can be modeled by a warehouse data access system and made accessible through business data queries. For example, a business data query can be a modeled request to an online analytic processing (OLAP) server to obtain data for reporting purposes. In general, the data for a given report obtained from an OLAP system can be provided using a business data query, e.g., modeled using business data query designer tools. The tools, for example, can be used to obtain information, e.g., from the “cube” of information associated with a particular information provider. A cube can be defined, for example, as a multi-dimensional representation and collection of data, e.g., used in OLAP systems, as well as including other definitions known in the art.

In some implementations, a business data query can include various functions, e.g., functions for defining a sub-cube of a cube and for defining an initial view. In functions for defining a sub-cube, reporting queries can be based on information providers. For example, an information provider can consist of a large number of dimensions spanned by characteristics and key figures. A business data query designed for a special business purpose may use only a subset of the provided dimensionality. The business data query designer can allow the user to choose the needed characteristics and key figures. In addition, characteristics can be restricted (e.g., filtered) to specific values, thus further reducing the dimensionality. The final effective information provider on which the query is based can also be referred to as a sub-cube. Thus, the sub-cube of a business data query can be the result of a pre-defined and fixed subset operation on the cube.

The function of the initial view can be to describe the layout of the report that the user will see when the query is initially executed. For example, a specific query layout can be referred to as a query view. The query view features can allow the query designer (e.g., a specific user role) to specify a detailed layout for a given reporting task. Example features include characteristics and their position in the axes (e.g., rows, columns, free, etc.), sorting of characteristic values, display of attributes of the characteristics, key figures and their visibility, default filters, conditions, exceptions, local calculations, hierarchy settings, currency translation settings and/or other features.

Business data queries can be executed and visualized with standard business data query front-end tools. Besides these internal tools, warehouse data access systems can offer an industry standard API, such as one using MDX for external reporting access. Because MDX is standardized, the API can be used by customers, partners or other external groups and/or users to obtain reporting data from an OLAP system.

For example, mobile applications can communicate using MDX commands/statements with warehouse data access system servers, in which an MDX interpreter can manage the execution of a provided MDX request. An analytical engine can then execute the request on the basis of the definition of the business data query and the data in the underlying information provider (e.g., the cube).

Mobile reporting applications can use business data queries to access information from the information provider. For example, the applications can use business data queries (e.g., using the API) to access relevant business system data.

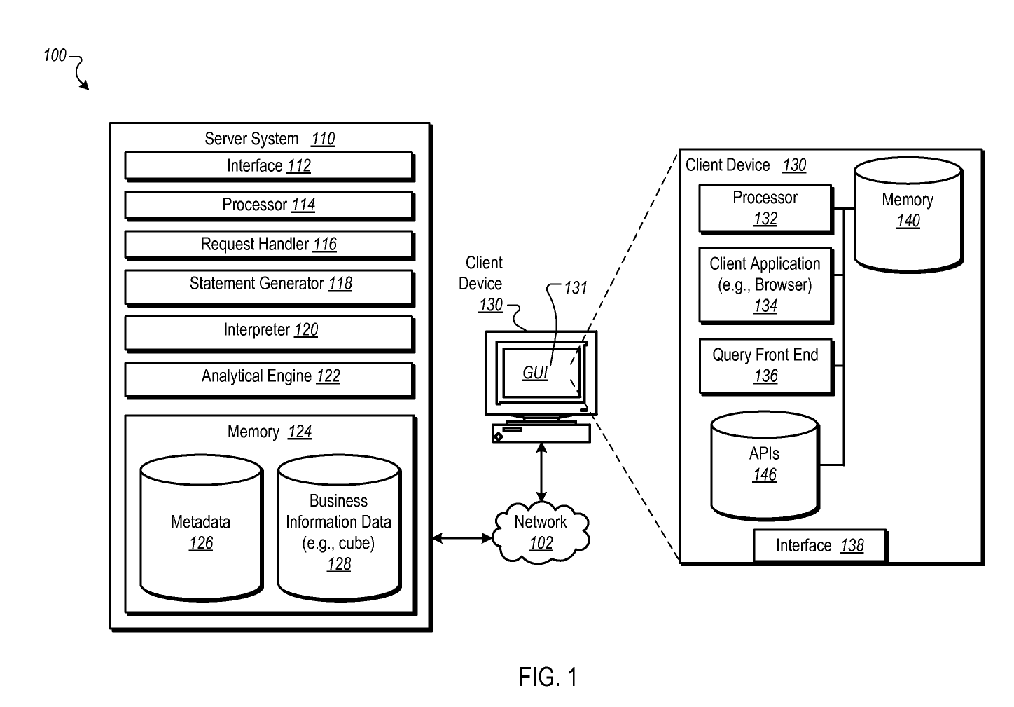

FIG. 1 illustrates an example environment 100 for using queries to obtain information according to an implementation. Specifically, the illustrated environment 100 includes at least one server system 110, and at least one client device 130, all of which are communicably coupled using a network 102. For example, a user interacting with a user interface presented on the client device 130 may access business-related information maintained by, or accessible through, the server system 110.

The server system 110 comprises an electronic computing device operable to generate statements, e.g., multi-dimensional query language statements. The server system 110 can also receive statements, e.g., for querying business information data 128 (e.g., a data warehouse).

Although FIG. 1 illustrates a single server system 110, the environment 100 can be implemented using two or more server systems 110. The environment 100 can also be implemented using computers other than servers, including a server pool. Indeed, components of the environment 100 may be any computer or processing device. According to some implementations, components of the environment 100 may also include, or be communicably coupled with, an e-mail server, a web server, a caching server, a streaming data server, and/or other suitable server(s). In some implementations, components of the environment 100 may be distributed in different locations and coupled using the network 102.

The server system 110 includes an interface 112, a processor 114, a request handler 116, a statement generator 118, a memory 124, and other elements as described below. The interface 112 is used by the server system 110 for communicating with other systems in a distributed environment, connected to the network 102 (e.g., the client device 130), as well as other systems (not illustrated) communicably coupled to the network 102. Generally, the interface 112 comprises logic encoded in software and/or hardware in a suitable combination and operable to communicate with the network 102. More specifically, the interface 112 may comprise software supporting one or more communication protocols associated with communications such that the network 102 or interface's hardware is operable to communicate physical signals within and outside of the illustrated environment 100.

The request handler 116 can, for example, handle requests received from systems and/or devices external to the server system 110. For example, the request handler 116 can handle a request received from the client device 130 to execute a query, e.g., that originates from a query front end 136.

In some implementations, the request handler 116 can provide received queries to an interpreter 120 for interpretation. For example, the interpreter 120 can be an MDX interpreter that can take care of the execution of a received MDX request. Once the received MDX request is interpreted, an analytical engine 122 can execute the request on the basis of the definition of the business data query and the data in the underlying information provider (e.g., the cube).

The statement generator 118 (or sub-components therein) can generate statements (e.g., MDX statements), e.g., associated with a received query. For example, the MDX statements can be statements that a user can use to obtain more detailed information associated with summary information received as query results.

The server system 110 also includes the memory 124. Although illustrated as a single memory 124 in FIG. 1, two or more memories may be used according to particular needs, desires, or particular implementations of the environment 100. While memory 124 is illustrated as an integral component of the server system 110, in alternative implementations, memory 124 can be external to the server system 110 and/or the environment 100. In some implementations, memory 124 includes the metadata 126 and/or the business information data 128. Other components within the memory 124 are possible. The statement generator 118 can use the metadata 126, for example, to generate additional statements (e.g., MDX statements).

The illustrated environment of FIG. 1 also includes the client device 130, or multiple client devices 130. The client device 130 may be any computing device operable to connect to, or communicate with, at least the server system 110 over the network 102 using a wire-line or wireless connection. In general, the client device 130 comprises an electronic computer device operable to receive, transmit, process, and store any appropriate data associated with the environment 100 of FIG. 1.

The illustrated client device 130 further includes at least one client application 134. Each client application 134 can be any type of application that allows the client device 130 to request and view content, such as a web browser or any other application that may display or use content. Other client applications 134 can include business applications, games, embedded systems (e.g., medical devices, airline/defense systems, etc.) and any other applications that can run on a client device 130, with or without user interaction.

The illustrated client device 130 further includes a query front end 136 for receiving queries from the user and displaying the results. For example, using the query front end 136, the user can provide (e.g., by selecting, typing, indicating, etc.) the technical name that is associated with a query that the user would like to submit. The query front end 136 can use APIs 146, e.g., including APIs for external reporting access.

The illustrated client device 130 further includes an interface 138, a processor 132, and a memory 140. The interface 138 is used by the client device 130 for communicating with other systems in a distributed environment—including within the environment 100—connected to the network 102. The interface 138 can support, for example, queries sent by the client device 130 to the server system 110. Generally, the interface 138 comprises logic encoded in software and/or hardware in a suitable combination and operable to communicate with the network 102. More specifically, the interface 138 may comprise software supporting one or more communication protocols associated with communications such that the network 102 or interface's hardware is operable to communicate physical signals within and outside of the illustrated environment 100.

As illustrated in FIG. 1, the client device 130 includes the processor 132. Although illustrated as the single processor 132 in FIG. 1, two or more processors 132 may be used according to particular needs, desires, or particular implementations of the environment 100. Generally, the processor 132 executes instructions and manipulates data to perform the operations of the client device 130. Specifically, the processor 132 executes the functionality required to send requests to, and process responses from, and the server system 110.

The illustrated client device 130 also includes a memory 140, or multiple memories 140 storing objects and/or data associated with the purposes of the client device 130 within the environment 100, including, in some implementations, for purposes such as backup, caching, and the like.

The illustrated client device 130 is intended to encompass any computing device configured and/or operable to connect to or to communicate with at least the server system 110 using the network 102. In some implementations, the client device 130 may comprise a computer that includes an input device, such as a keypad, touch screen, or other device that can accept user information, and an output device that conveys information associated with the client device 130, including digital data, visual information, or a graphical user interface (GUI) 131, as shown with respect to and included by the client device 130. The GUI 131 interfaces with at least a portion of the environment 100 for any suitable purpose, including generating a visual representation of a web browser, providing an interface for displaying a control for identifying and submitting queries, and for other purposes. There may be any number of client devices 130 associated with, or external to, the environment 100. For example, while the illustrated environment 100 includes one client device 130 communicably coupled to the server system 110 using network 102, alternative implementations of the environment 100 may include any number of client devices 130 suitable to the purposes of the environment 100. Additionally, there may also be one or more additional client devices 130 external to the illustrated portion of the environment 100 that are capable of interacting with the environment 100 using the network 102. Further, the term “client” and “user” may be used interchangeably as appropriate without departing from the scope of this disclosure. Moreover, while the client device 130 is described in terms of being used by a single user, this disclosure contemplates that many users may use one computer, or that one user may use multiple computers.

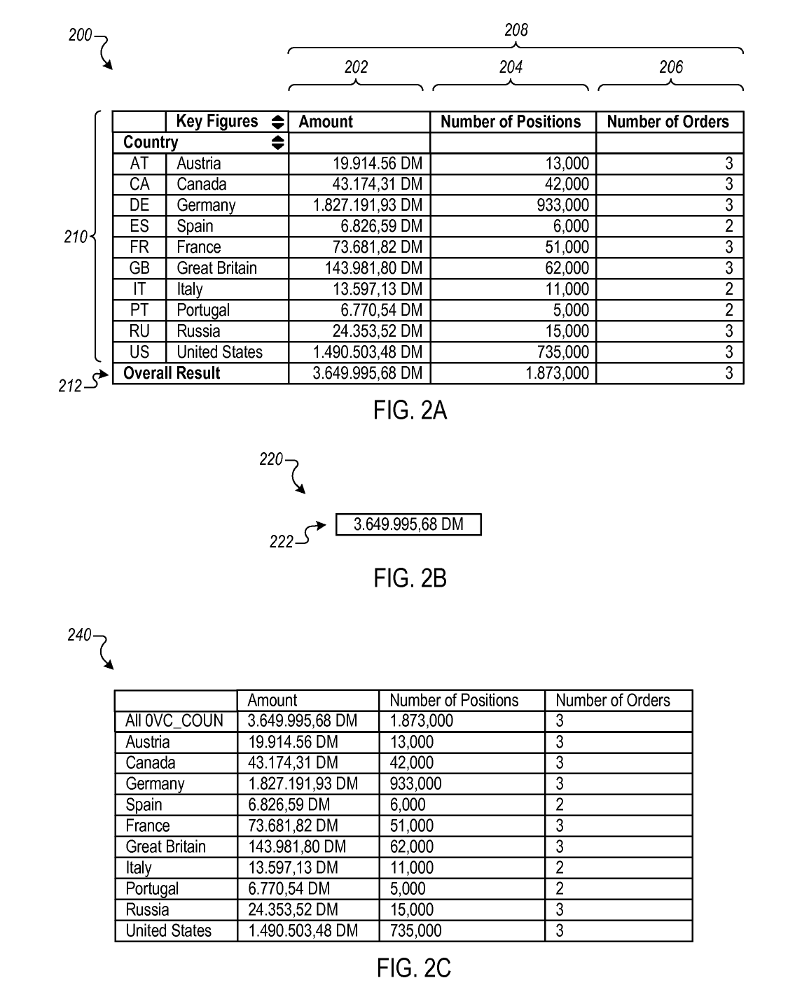

FIG. 2A shows example query results 200 associated with a first query executed in a native (e.g., internal) environment according to an implementation. For example, the query can be entered by a user (e.g., an internal user) using a user device that is interfaced directly with a reporting system for generating query results. The query results in this example include business-related information, sub-totaled by country, including amounts, number of positions and number or orders, all of which appear as query results because the corresponding query originates from an internal user. In this example, the query results 200 for a query having a technical name (e.g., KEY_FIGURES_DEMO) contain three key figures 202-206 (e.g., “Amount”, “Amount of Positions” and “Number of Orders”) on a columns axis 208. The query results 200 also include a dimension on the rows axis 210 (e.g., “Country”). In some implementations, characteristics such as rows (e.g., “Country”) and columns (e.g., key figures “Amount”, “Amount of Positions” and “Number of Orders”) in this example can be considered as dimensions in a business information warehouse system. The query results 200 can represent, for example, information that is displayed to a user as the result of executing a query (e.g., identified by its technical name) in the native environment, e.g., using a front-end tool or interface.

In the current example, each row in the query results 200 identifies the key figures for the corresponding country identified by the rows axis 210. The query results 200 also include an overall result 212, e.g., that provides totals for each of the columns representing key figures 202-206. Other types of overall results 212 are possible, such as averages, medians, and other statistical or mathematical forms. In some implementations, the query can be submitted for execution by providing only the technical name (e.g., KEY_FIGURES_DEMO) of the query. For example, technical names can be used to name queries which, upon execution, provide an initial query view having a specific pre-defined business semantic (e.g., to display just the grand total of plural elements).

FIG. 2B shows example query results 220 associated with the first query executed through an API according to an implementation. In this example as well, the query can be executed by just providing the technical name (e.g., KEY_FIGURES_DEMO). However, in this example, because the query is executed through the API, the query results 220 can display just the grand total 222 (e.g., that correspond to the overall result 212). In this example, the results of the query are different from the query results described with reference to FIG. 2A, as the user in this example is an external user. The results are different, as explained above, because a query from an external source using MDX has different results. In some implementations, these results can be different for a mobile user versus a native user. For example, even though the multi-dimensional query language statements are based on the same query as executed natively (with reference to FIG. 2A), the API only uses sub-level aspects of the query definition for the query access, as in the following statement:

| SELECT | |
|---|---|
| FROM | |
| [0BWVC_C03/KEY_FIGURES_DEMO] | (1) |

In some implementations, the multi-dimensional query language can require all layout information to be part of each statement and can ignore all previous layout definitions—including the query view of the first query. For example, the figure “3.649.995,68 DM” can be the result of the standard multi-dimensional query language default logic, e.g., if no layout is specified, then the aggregate of the first key figure is displayed. In this example, the query result can correspond to the overall result of the “Amount” of the query. In this example, by providing just the technical name of the query, the user may lose part of the query functionality, including potentially important business content.

FIG. 2C shows example query results 240 associated with a second query for obtaining detailed information, including receiving the data and a layout, according to an implementation. For example, if the mobile user wants to obtain the same result as provided in FIG. 2A, the user must manually extend the multi-dimensional query language statement with a layout definition. As an example, the multi-dimensional query language statement can include:

| SELECT | |
|---|---|
| NON EMPTY | |
| { [0008I83HW93C9T34UUKJJSA7W].Members } | |
| ON COLUMNS, | |
| NON EMPTY | |
| { [0VC_CUST_OVC_COUN].Members } | |
| ON ROWS | |
| FROM | |
| [0BWVC_C03/SEB_MDX_DEMO] | (2) |

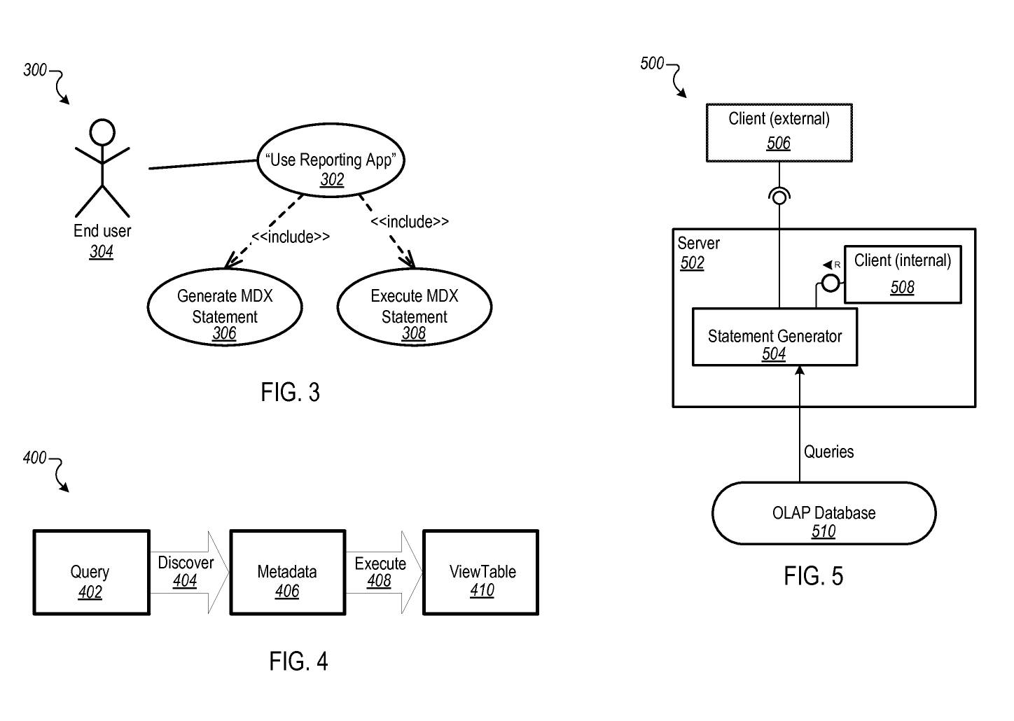

FIG. 3 shows a diagram of an example abstraction 300 of a reporting application 302 according to an implementation. For example, from the point-of-view of an end user 304, the abstraction 300 can show that the end user 304 just wants to use the reporting application 302 to obtain information from a business information warehouse system. Implementation details of how the mobile application communicates with the business information warehouse system can remain hidden to the end user 304. As such, the reporting application 302 can include two basic steps, e.g., a statement generation step 306 and an execution step 308. The statement generation step 306, e.g., performed by the interpreter 120, can generate the multi-dimensional query language statement (e.g., MDX statement) for the query view, e.g., for display to the end user 304. The execution step 308, e.g., performed by the analytical engine 122, can execute the multi-dimensional query language statement to get the result (e.g., query results) to display to the end user 304, and also return layout information.

FIG. 4 shows a diagram of an example sequence of operations 400 for the reporting application of FIG. 3 according to an implementation. For example, the sequence of operations 400 can apply for a query 402 submitted from a device by providing the technical name (e.g., KEY_FIGURES_DEMO). In some implementations, the reporting application 302 can work with XMLA (XML for analysis). In some implementations, the basic steps in XMLA can include a discover method 404 (e.g., for obtaining metadata 406 (e.g., layout information) associated with the query 402) and an execute method 408 (e.g., to obtain the actual results of the query 402). In some implementations, the sequence of operations 400 can be included in an MDX generator, e.g., that can include or be associated with an XMLA specification.

In some implementations, the query 402 to be executed can be referenced with the technical name and used when calling the discover method 404 to retrieve the metadata 406. After that it is known, e.g., using stored view information indexed by technical name, how the result view will appear (e.g., captions, dimensions, etc.). The actual query result can be obtained, for example, using the execute method 408. In some implementations, using the metadata, the query results can be then rendered in a view table 410. In some implementations, one purpose of the metadata is to render the view table (e.g., to get the number of columns/rows and the labels).

FIG. 5 shows a diagram of an example architecture 500 that includes a server 502 for handling multi-dimensional queries according to an implementation. For example, the server 502 can be a server for a business information warehouse system. In some implementations, a statement generator 504 (e.g., an MDX generator) inside the server 502 can generate multi-dimensional query language statements that include the information of the query view for a given query name received as input. The statement generator 504, for example, can return a multi-dimensional query language (e.g., MDX) statement that includes the whole query view. In some implementations, the statement generator 504 can support the query features mentioned above. In some implementations, in addition to being used by external clients 506 (e.g., from mobile apps), the statement generator 504 can be used by internal consumers 508. One example use by internal consumers can be testing, e.g., by embedding the statement generator 504 into an existing business information warehouse system test. Other example uses include analysis tools for both functionality and quality.

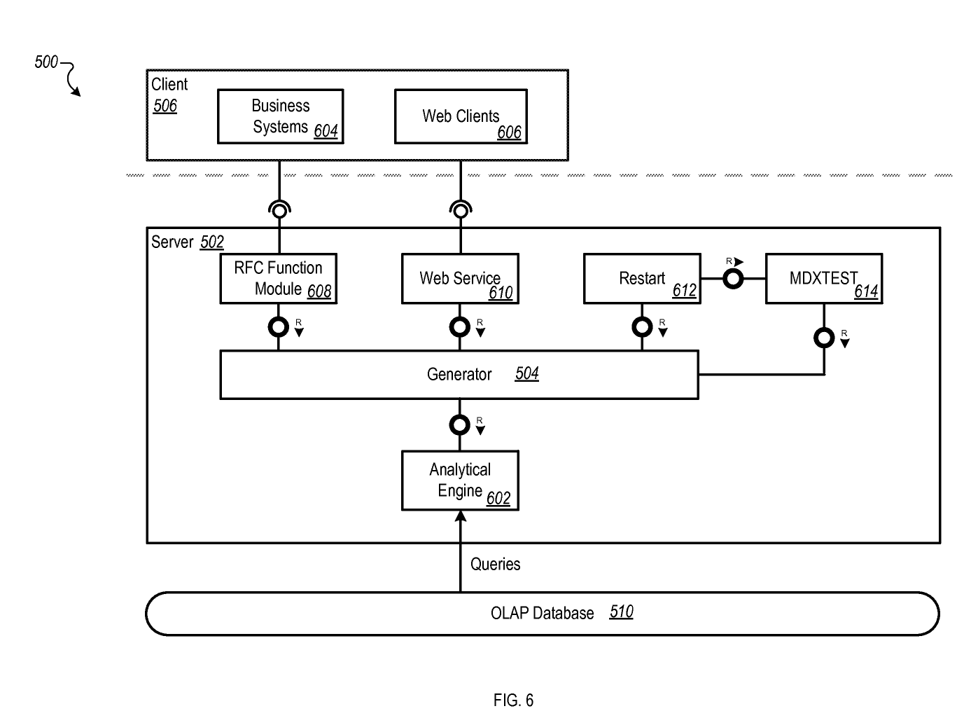

FIG. 6 shows more detail of the example architecture shown in FIG. 5 according to an implementation. In this example, the statement generator 504 can communicate directly with an analytical engine 602 to get the required metadata information associated with the query. In some implementations, the server 502 can include interfaces to external consumers, such as to business systems 604 and web clients 606. For example, the interfaces can include a remote function call (RFC) protocol function module 608 and a web service 610 (e.g., that uses HTTP). Internal tools of the server 502 can include a restart/query monitor 612 and a test module 614 (e.g., for directly calling program artifacts of the statement generator 504).

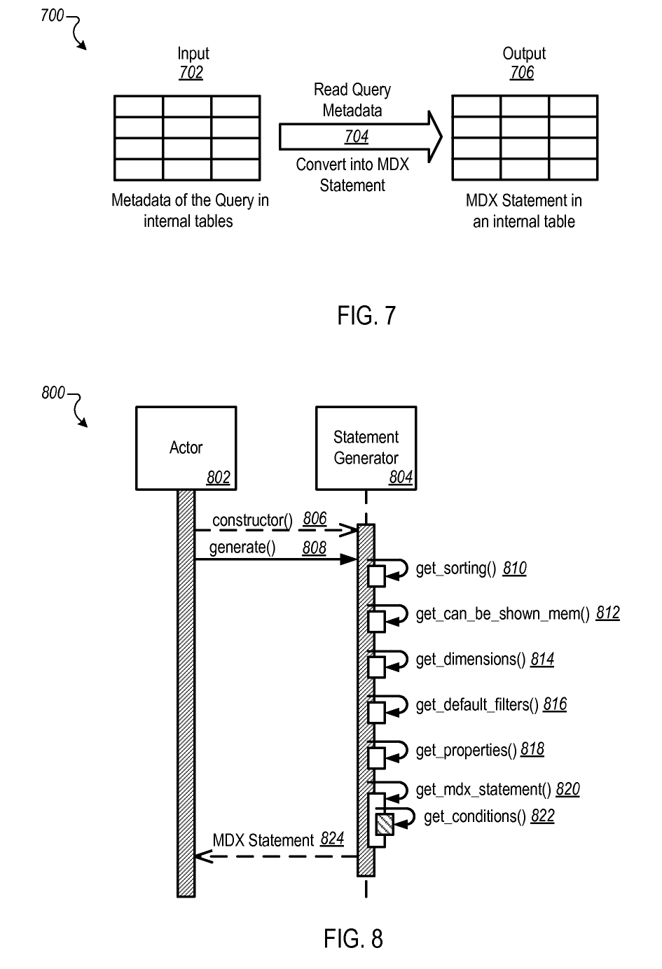

FIG. 7 shows a diagram of an example mechanism 700 for reading metadata associated with a given query and converting the information into a multi-dimensional query language statement according to an implementation. For example, the statement generator 504 can read input 702 (e.g., metadata of the query in internal tables) and convert (704) the metadata into output 706 (e.g., multi-dimensional query language statements in an internal table). For example, the input 702 can correspond to the metadata associated with the query represented by Statement 1. The output 706, for example, can correspond to Statement 2.

FIG. 8 shows a swim lane diagram of an example sequence 800 of methods 806-826 for generating multi-dimensional query language statements according to an implementation. For example, the sequence 800 can occur between an actor 802 (e.g., an end user) and a statement generator 804 (e.g., the statement generator 504). In some implementations, a constructor method 806, used by the actor 802, can initiate the sequence 800. A generate method 808 includes, as input, the query name, e.g., a technical name (e.g., KEY_FIGURES_DEMO), and can return the multi-dimensional query language (e.g., MDX) statement. The constructor method 806, for example, can create an object of the generator class. In some implementations, a public generate method can call the private methods 810-822. Methods 810-818, for example, can be used to read and analyze metadata, extract query view information for the different features in the view from the metadata, and store information in an intermediate structure. After having prepared the intermediate results, the MDX statement can be compiled by a get statement method 820, including using a get conditions method 822 to access conditions associated with the statement.

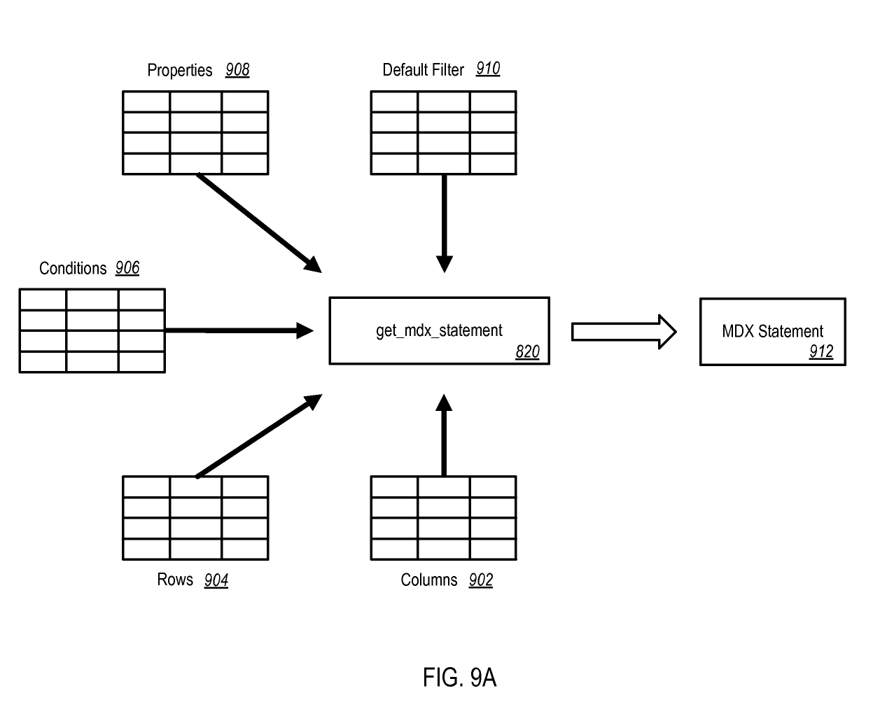

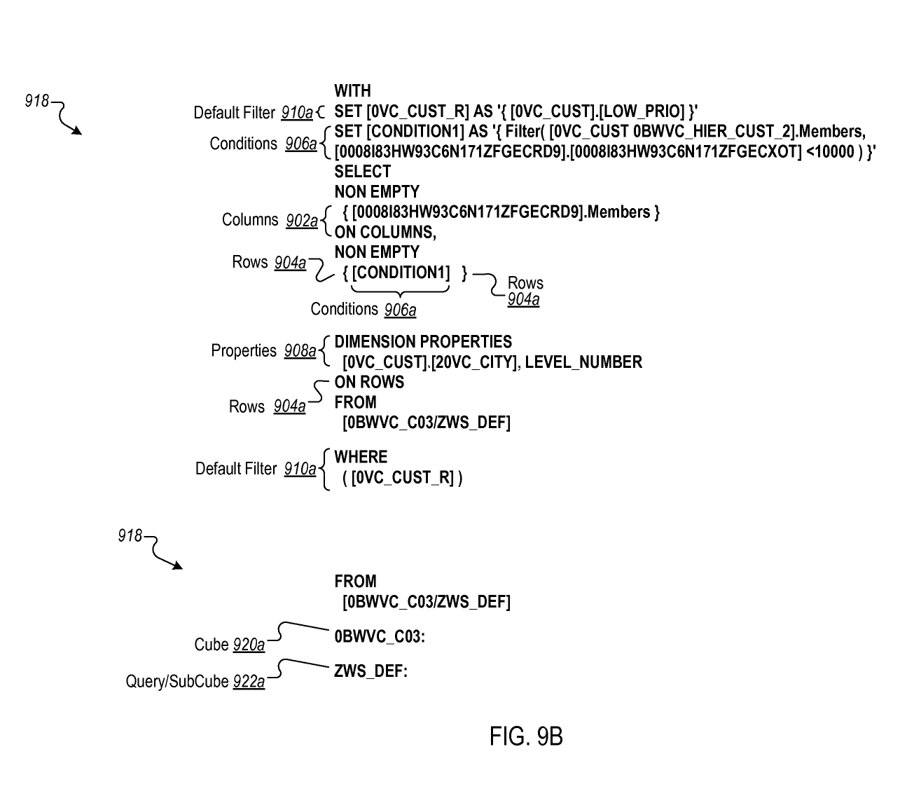

FIG. 9A shows a diagram of example inputs for a get query statement function according to an implementation. For example, the get query statement function can be the get statement method 820 described above, e.g., for getting an MDX statement. In some implementations, the get statement method 820 can consider previously extracted information from a query view, e.g., stored in a set of internal tables 902-910. For example, the get statement method 820 can parse the internal tables 902-910 to generate the statement 912. Tables 902-910, for example, can contain query parts/metadata that can be used and converted into an MDX statement.

FIG. 9B shows example inputs for the get query statement function of FIG. 9A, according to an implementation. For example, sample inputs 902a-910a identify portions of query statements 918 that correspond to the internal tables 902-910 and inputs of the method 820. A sample cube 920a and a sample sub-cube 922 are also shown.

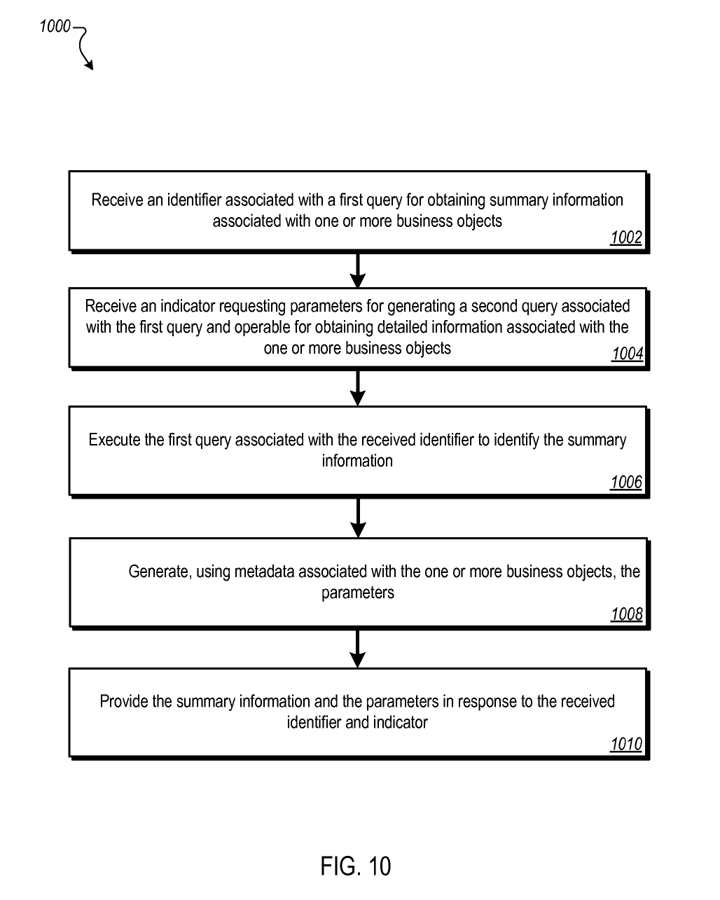

FIG. 10 shows a flowchart of an example method 1000 for providing summary information and parameters for use in generating a query for associated detailed information according to an implementation. For clarity of presentation, the description that follows generally describes method 1000 in the context of FIGS. 1 through 9. However, it will be understood that the method 1000 may be performed, for example, by any other suitable system, environment, software, and hardware, or a combination of systems, environments, software, and hardware as appropriate.

At 1002, an identifier is received that is associated with a first query for obtaining summary information associated with one or more business objects. For example, the server system 110 can receive an identifier from the client device 130 that is associated with a query selected to be run by a user of the client device 130. The query, for example, can be a query that is designed to produce query results 220 that include the grand total 222.

In some implementations, the identifier is a technical name that is associated with an information provider and identified by the identifier. For example, the identifier can be the technical name KEY_FIGURES_DEMO or some other name that is associated with the information provider that provides key figures-related information.

In some implementations, the summary information is based on predefined dimensions (e.g., characteristics) and key figures associated with the information provider. For example, the summary information can be the grand total 222 that is associated with the three key figures 202-206 (e.g., “Amount”, “Amount of Positions” and “Number of Orders”).

At 1004, an indicator is received that requests parameters for generating a second query associated with the first query and operable for obtaining detailed information associated with the one or more business objects. For example, in the same request received from the client device 130, there can be instructions that specify that the server system 110 is also to provide parameters that can be used by the client device 130 to obtain addition detailed data associated with the query. As an example, the indicator can request parameters that can be used to generate a query (e.g., including Statement 2 above) to produce the query results 240 described above with reference to FIG. 2B.

In some implementations, the second query is associated with a view describing a layout of the detailed information. As an example, the second query can be associated with the view shown in the query results 240, described above with reference to FIG. 2C.

In some implementations, the parameters include an executable instance of the second query. As an example, the second query can include Statement 2, described above with reference to FIG. 2C, or an executable query that includes Statement 2.

In some implementations, the parameters include building blocks that are usable by a user to formulate the second query. For example the parameters can include information that is displayed at the client device 130 (e.g., in the GUI 131) that the user can select from to build the second query. In some implementations, the parameters can be labeled in the GUI 131, e.g., so that the user is informed of the results that may be obtained by including certain parameters when the second query is executed.

In some implementations, the parameters are represented in a multi-dimensional expression language. For example, the parameters provided by the server system 110 can be in the form of an MDX statement.

At 1006, the first query associated with the received identifier is executed to identify the summary information. For example, the interpreter 120 can execute the query (e.g., Statement 1).

In some implementations, executing the first query includes, depending on at least a source of the first query, one of two possible results. When an API is used for executing the first query, executing the first query includes providing a first result set that includes the summary information. For example, if the first query is submitted remotely, e.g., from a mobile device, the first query can be submitted through the query front end 136 using at least one of the APIs 146. The result in this example can be the query results 220, e.g., that include just the grand total 222. When the first query is instead executed in a native environment, executing the first query includes providing a second result set that includes the summary information and the detailed information. In this example, the first query is submitted from within a native environment. For example, the query can be entered by a user using a user device that is interfaced directly with the server system 110.

At 1008, the parameters are generated using metadata associated with the one or more business objects. For example, the statement generator 118 can produce Statement 2 described above.

At 1010, the summary information and the parameters are provided in response to the received identifier and indicator. For example, the server system 110 can provide the query results 220 and parameters associated with Statement 2.

In some implementations, the method 1000 further includes receiving the second query, executing the second query, and providing the detailed information in response to the received second query. For example, the server system 110 can receive execute the second query, e.g., in the form of Statement 2, and send the query results 240 back to the client device 130.

In some implementations, providing subsequent query results can include providing parameters for yet additional queries. For example, in addition to returning the query results corresponding to the second query, the server system 110 can provide parameters for a third query, e.g., to obtain detailed information associated with the query results.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, example environment 100 may use processes with additional, fewer and/or different operations, as long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

What is claimed is:

1. A computer-implemented method comprising:
receiving an identifier associated with a first query for obtaining summary information associated with one or more business objects;
receiving an indicator requesting parameters for creating a second query associated with the first query and operable for obtaining detailed information associated with the one or more business objects;
executing, using one or more processors, the first query associated with the received identifier to identify the summary information;
creating, using metadata associated with the one or more business objects, the parameters; and
providing the summary information and the parameters in response to the received identifier and indicator.

2. The computer-implemented method of claim 1, wherein the identifier is a technical name associated with an information provider and identified by the identifier.

3. The computer-implemented method of claim 2, wherein the summary information is based on predefined dimensions and key figures associated with the information provider.

4. The computer-implemented method of claim 1, wherein the second query is associated with a view describing a layout of the detailed information.

5. The computer-implemented method of claim 1, wherein the parameters include an executable instance of the second query.

6. The computer-implemented method of claim 1, wherein the parameters include building blocks usable to formulate the second query.

7. The method of claim 1, wherein executing the first query includes, depending on at least a source of the first query, one of:
providing a first result set that includes the summary information when an API is used for executing the first query; and
providing a second result set that includes the summary information and the detailed information when the first query is executed in a native environment.

8. The method of claim 1, wherein the parameters are represented in a multi-dimensional expression language.

9. The computer-implemented method of claim 1, further comprising:
receiving the second query;
executing the second query; and
providing the detailed information in response to the received second query.

10. The computer-implemented method of claim 1, further comprising:
providing parameters for creating a third query associated with the second query and operable for obtaining additional detailed information associated with the one or more business objects;
receiving the third query;
executing the third query; and
providing the additional detailed information in response to the received third query.

11. A computer-readable media, the computer-readable media comprising computer-readable instructions embodied on tangible, non-transitory media, the instructions operable when executed by at least one computer to:
receive an identifier associated with a first query for obtaining summary information associated with one or more business objects;
receive an indicator requesting parameters for creating a second query associated with the first query and operable for obtaining detailed information associated with the one or more business objects;
execute, using one or more processors, the first query associated with the received identifier to identify the summary information;
create, using metadata associated with the one or more business objects, the parameters; and
provide the summary information and the parameters in response to the received identifier and indicator.

12. The computer-readable media of claim 11, wherein the identifier is a technical name associated with an information provider and identified by the identifier.

13. The computer-readable media of claim 12, wherein the summary information is based on predefined dimensions and key figures associated with the information provider.

14. The computer-readable media of claim 11, wherein the second query is associated with a view describing a layout of the detailed information.

15. The computer-readable media of claim 11, wherein the parameters include an executable instance of the second query.

16. A computer system, comprising:
memory operable to store content, including static and dynamic content; and
at least one hardware processor interoperably coupled to the memory and operable to perform instructions to:
receive an identifier associated with a first query for obtaining summary information associated with one or more business objects;
receive an indicator requesting parameters for creating a second query associated with the first query and operable for obtaining detailed information associated with the one or more business objects;
execute, using one or more processors, the first query associated with the received identifier to identify the summary information;
create, using metadata associated with the one or more business objects, the parameters; and
provide the summary information and the parameters in response to the received identifier and indicator.

17. The computer system of claim 16, wherein the identifier is a technical name associated with an information provider and identified by the identifier.

18. The computer system of claim 17, wherein the summary information is based on predefined dimensions and key figures associated with the information provider.

19. The computer system of claim 16, wherein the second query is associated with a view describing a layout of the detailed information.

20. The computer system of claim 16, wherein the parameters include an executable instance of the second query.
